(19) United States
(12) Patent Application Publication
(10) Pub. No.: US 2015/0220228 A1
(43) Pub. Date: Aug. 6, 2015

(54) Systems Methods Circuits and Associated Computer Executable Code for Arranging and Organizing Computerized Application Tabs Based on Content Service and User Characterization

(71) Applicant: Yoav Podemsky, Tel Aviv (IL)

(72) Inventor: Yoav Podemsky, Tel Aviv (IL)

(21) Appl. No.: 14/173,963

(22) Filed: Feb. 6, 2014

(51) Int. Cl. G06F 3/0483

(52) U.S. Cl. CPC G06F 3/0483

(57) ABSTRACT

Disclosed are systems, methods, circuits, and associated computer executable code for arranging and organizing content or service related tabs. A characterization module characterizes content or services associated with each of one or more software application tabs. An interface configuration module configures one or more appearance attributes of some or all of the one or more tabs, based on an arrangement rule-set that at least partially factors information of tab associated content or services provided by the characterization module.

### FIELD OF THE INVENTION

The present invention relates generally to the fields of User Interface Design and User Interface Customization. More specifically, the present invention relates to systems, methods, circuits, and associated computer executable code for arranging and organizing computerized application tabs, based on content, service and/or user characterization.

### BACKGROUND

User interface design or user interface engineering is the design of websites, computers, appliances, machines, mobile communication devices, and software applications with the focus on the user's experience and interaction. The goal of user interface design is to make the user's interaction as simple and efficient as possible, in terms of accomplishing user goals—what is often called user-centered design. Good user interface design facilitates finishing the task at hand without drawing unnecessary attention to itself. Graphic design may be utilized to support its usability. The design process must balance technical functionality and visual elements (e.g. mental model) to create a system that is not only operational but also usable and adaptable to changing user needs.

Research in recent years is strongly motivated by the increasing variety of devices that can, by virtue of Moore's Law, host very complex interfaces. Research has also been conducted on generating user interfaces automatically, to match a user's level of ability for different levels of interaction.

For a relatively long period following to their initial introduction and wide user acceptance, Internet web browsers did not utilize tabs, and tab enabled functionality, as part of their user interface. Separate websites/web-pages were presented over separate web browser application windows. Once introduced into web browsers, within a short while tabs were adopted by most web browsers, and became a standard web browser feature.

With more and more applications and everyday activities (e.g. shopping, use of financial services, medical services) migrating to the ‘cloud’, many applications, and web browsers in particular, now host and offer a large number of functionalities, often resulting in complex and cumbersome interfaces—containing a substantially large, and often unmanageable, number of tabs—that are less efficient and demand more user effort and time when navigating or moving between applications, contents and/or services.

Taking the above into account, there clearly remains a need, in the field of User Interface Design and User Interface Customization, for better and more efficient systems and methods for software application interface tabs arrangement, organization and customization that are at least partially based on the characterization of content and/or services associated with the application's tabs, and/or software application user and/or usage characterization.

### SUMMARY OF THE INVENTION

The present invention includes methods, circuits, apparatuses, systems and associated computer executable code for arranging and/or organizing content or service related tabs, for example, within a web browser. According to some embodiments, a characterization module, integral or otherwise functionally associated with a computerized application (e.g. a web-browser application), may characterize content or services (e.g. web-based applications) associated with each of one or more application (e.g. web-browser) tabs. An interface configuration module, integral or otherwise functionally associated with the application (e.g. web-browser application), may arrange or rearrange a location of a tab, and/or may adjust or readjust an appearance attribute of a tab, in accordance with an arrangement rule-set, which arrangement rule-set may at least partially factor characterization information relating to content or services being rendered or presented within the application (e.g. web-browser) tab.

The characterization module may characterize content and/or services rendered or presented within a tab using one or more of a variety of methods. It should be understood that characterization of a tab is analogous to characterization of content and/or services (directly [e.g. based on content metadata] or indirectly [e.g. based on the content user's geo position] characterized using any combination of the information types and sources described hereinafter), rendered or presented therein, and the two concepts and all associated terms used to describe the concepts may be used interchangeably.

According to some embodiments, a tab may be characterized using a lookup table which correlates or cross references URL's or internet addresses (e.g. for web browser applications), and/or pointers/links/paths or memory addresses (e.g. for local applications), with specific content and/or service characterizations or categories. Content and/or service characterizations may be provided in the form of characterization terms, characterization values and/or characterization codes. As part of characterizing a given tab, the characterization module may reference one or more records of the lookup table using the URL or internet addresses associated with the given tab (e.g. URL to which the tab is pointing), and the characterization module may derive from one or more matching or identified table records one or more characterizations, such as characterization terms or characterization codes. Each of the one or more characterizations from the identified matching records may identify a category associated with the content/services rendered within a tab and the given tab may be characterized by, or associated with, the one or more content/service categories. The lookup table may be a static or dynamic table. The table records may be universal and/or at least partially user defined.

According to some further embodiments, a tab and its associated content may, for example, be characterized using metadata presented by a source of the content/service(s).

The interface configuration module may adjust location and appearance of tab rendering based on a rule-set, which rule-set may factor tab characterization or category associations. According to some embodiments, all tabs associated with the same or similar categories may be rendered in proximity with one another, for example as part of the same tab grouping. According to further embodiments, all tabs associated with complementing categories may be rendered in proximity with one another, for example as part of the tab grouping. Tab or tab group appearance and/or location may be adjusted or readjusted based on present relevance of content/services within the tabs/groups at during a given instance.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a functional block diagram of a general configuration of an exemplary system for arranging content or service related tabs, in accordance with some embodiments of the present invention, wherein web-browser application tabs positions are rearranged or one of their appearance attributes is changed;

FIG. 2 is a functional block diagram of an exemplary system for arranging content or service related tabs of a web-browser application, in accordance with some embodiments of the present invention;

FIG. 3 is a functional block diagram of an exemplary system for arranging content or service related tabs of a locally running application, in accordance with some embodiments of the present invention;

FIG. 4 is a functional block diagram of an exemplary system for arranging content or service related tabs of a locally running application, in accordance with some embodiments of the present invention, wherein the tab arrangement application is separate from the locally running, tab using, application;

FIG. 5 is a functional block diagram of an exemplary system for arranging content or service related tabs of a web-browser application, in accordance with some embodiments of the present invention, wherein internal and external website characterization databases, and a tab arrangement interface module, are shown;

FIG. 6 is a functional block diagram of an exemplary system for arranging content or service related tabs of a locally running application, in accordance with some embodiments of the present invention, wherein an external networked characterization database is used to characterize the content/service of the locally running, tab using, application;

FIG. 7 is a flowchart showing the main steps executed by an exemplary system for arranging content or service related tabs, in accordance with some embodiments of the present invention;

FIG. 8A is a schematic web browser screen rendering of an exemplary tab arrangement, configured by a system for arranging content or service related tabs in accordance with some embodiments of the present invention, wherein some of the web browser tabs group a set of related tabs; and wherein grouped tabs, of a set of related tabs, are displayed as a ‘drop down’ menu when their group tab is selected;

FIG. 8B is a schematic web browser screen rendering of an exemplary tab arrangement, configured by a system for arranging content or service related tabs in accordance with some embodiments of the present invention, wherein grouped tabs, of a set of related tabs, are displayed as ‘floating balloons’ when their group tab is selected;

FIG. 8C is a schematic web browser screen rendering of an exemplary tab arrangement, configured by a system for arranging content or service related tabs in accordance with some embodiments of the present invention, wherein a tab groups list is displayed as a first ‘drop down’ menu when a designated ‘groups button’ tab is selected; and wherein grouped tabs, of a set of related tabs, are displayed as a second ‘drop down’ menu when their group is selected from the first ‘drop down’ menu;

FIG. 9A is a schematic, mobile device, web browser screen rendering of an exemplary tab arrangement, configured by a system for arranging content or service related tabs in accordance with some embodiments of the present invention, wherein some of the mobile web browser tabs group a set of related tabs; and wherein grouped tabs, of a set of related tabs, are displayed on the screen when their group tab is selected; and

FIG. 9B is a schematic, mobile device, web browser screen rendering of an exemplary tab arrangement, configured by a system for arranging content or service related tabs in accordance with some embodiments of the present invention, wherein some of the mobile web browser tabs group a set of related tabs; and wherein grouped tabs and regular tabs menu is revealed and displayed when the device screen is swiped from the side.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals, or titles, may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

### General

The present invention includes methods, circuits, apparatuses, systems and associated computer executable code for arranging and/or organizing content or service related tabs, for example, within a web browser. According to some embodiments, a characterization module, integral or otherwise functionally associated with a computerized application (e.g. a web-browser application), may characterize content or services (e.g. web-based applications) associated with each of one or more application (e.g. web-browser) tabs. An interface configuration module, integral or otherwise functionally associated with the application (e.g. web-browser application), may arrange or rearrange a location of a tab, and/or may adjust or readjust an appearance attribute of a tab, in accordance with an arrangement rule-set, which arrangement rule-set may at least partially factor characterization information relating to content or services being rendered or presented within the application (e.g. web-browser) tab.

According to some embodiments, the arrangement rule-set may include one or more of the following rule types: (1) Default system rules—defining system-set content or services categories, the default characterization features/attributes and/or characterization features/attributes thresholds required for inclusion in each of the categories, and/or rendering characteristics thereof; (2) User defined rules—changes, additions and/or exceptions to any of the default rules, made by an interfacing user; and/or (3) System ‘understanding’ based rules—characterization information, and/or characterization based categorization information, relating to content or services being rendered or presented within the application. According to some embodiments, system ‘understanding’ based rules may be constructed using known in the art machine learning algorithms such as: logistic regression, support vector machines, Bayesian networks based classifications, and/or any other machine learning algorithm, or combination of machine learning algorithms, known today or to be devised in the future.

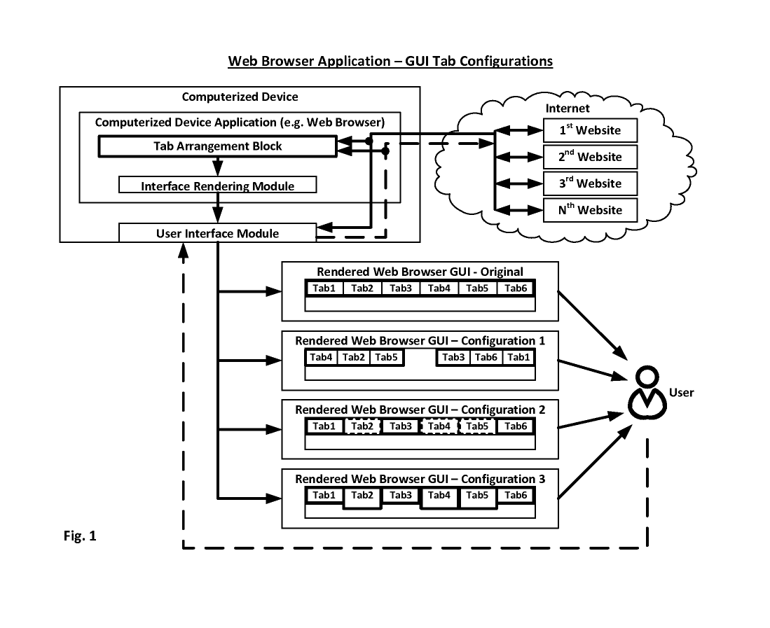

In FIG. 1 there is shown, in accordance with some embodiments of the present invention, a functional block diagram of a general configuration of an exemplary system for arranging content or service related tabs wherein web-browser application tabs positions are rearranged or one of their appearance attributes is changed. According to some embodiments, the Tab Arrangement Block, based on characterization of websites' contents/services, configures the originally rendered web-browser GUI to differentiate between tabs related to different categories of contents/services, by the following exemplary reconfigurations: grouping related tabs by changing the positions of tabs related to the same category (Configuration 1), changing the borders of tabs related to the same category (Configuration 2), and changing the size of tabs related to the same category (Configuration 3).

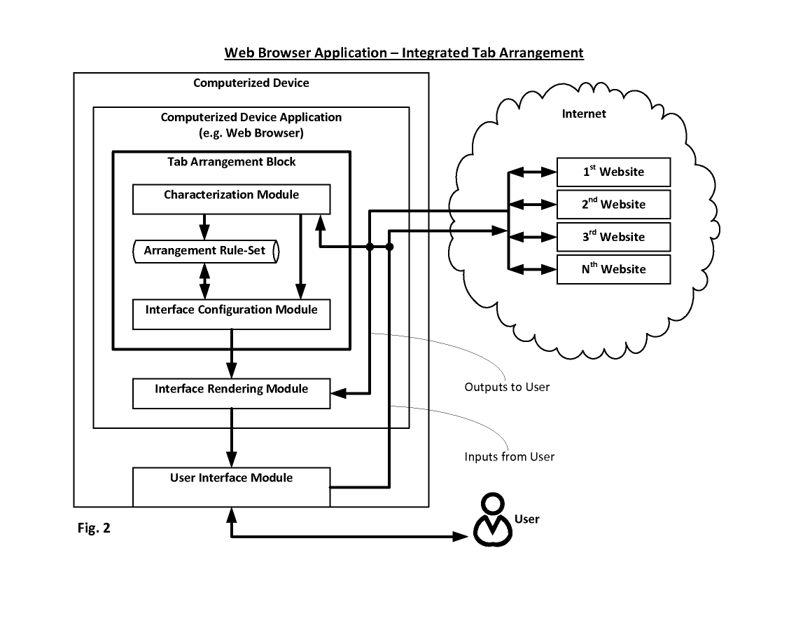

In FIG. 2 there is shown, in accordance with some embodiments of the present invention, a functional block diagram of an exemplary system for arranging content or service related tabs of a web-browser application. According to some embodiments, websites' web browser outputs to user and user web browser inputs to websites are monitored by the Characterization Module. The Characterization Module thus characterizes the contents/services associated with the web browser tabs, and accordingly modifies the Arrangement Rule-Set. The Interface Configuration Module, at least partially factoring the modified Arrangement Rule-Set, relays rendering modification instructions to the web browser's Interface Rendering Module for rendering on the User Interface Module.

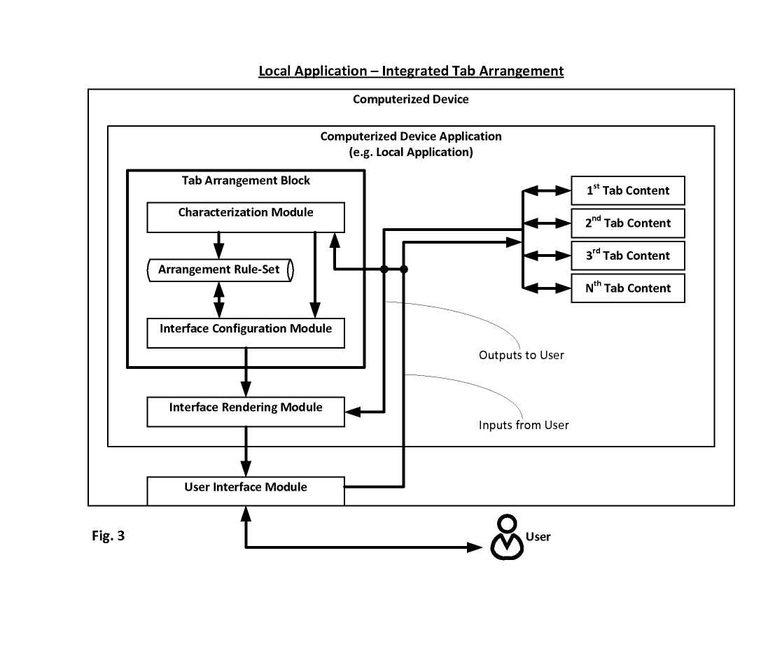

In FIG. 3 there is shown, in accordance with some embodiments of the present invention, a functional block diagram of an exemplary system for arranging content or service related tabs of a locally running application. The Computerized Device Application (a local application in this example) includes a Tab Arrangement Block which handles the characterization and configuration of the tabs of the Computerized Device Application.

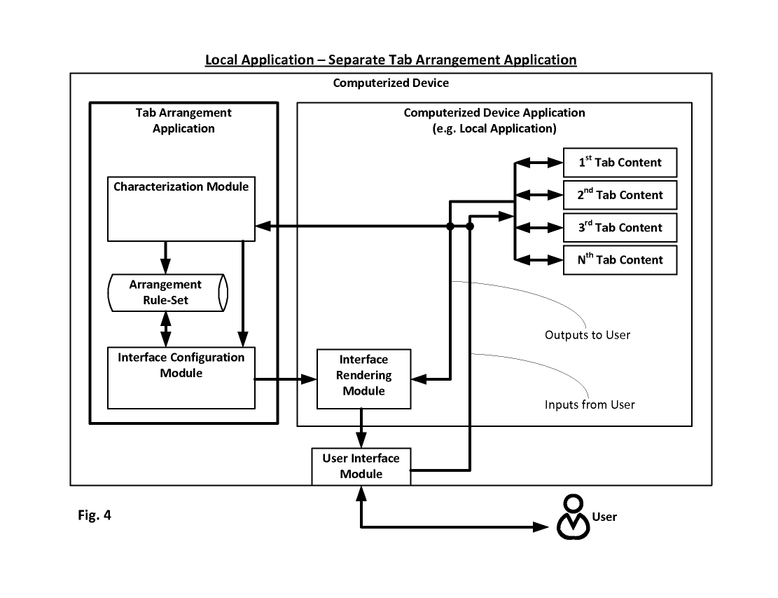

In FIG. 4 there is shown, in accordance with some embodiments of the present invention, a functional block diagram of an exemplary system for arranging content or service related tabs of a locally running application. The Computerized Device Application (a local application in this example) is functionally associated with a Tab Arrangement Application, running on the same Computerized Device, which handles the characterization and configuration of the tabs of the Computerized Device Application.

### Characterization

The characterization module may characterize content and/or services rendered or presented within a tab using one or more of a variety of methods. It should be understood that characterization of a tab is analogous to characterization of content and/or services (directly [e.g. based on content metadata] or indirectly [e.g. based on the content user's geo position] characterized using any combination of the information types and sources described hereinafter), rendered or presented therein, and the two concepts and all associated terms used to describe the concepts may be used interchangeably.

According to some embodiments of the present invention, content and/or services rendered or presented within a tab may be characterized, and/or accordingly categorized, based on: (1) Information from, or related to, the user's usage and interfacing characteristics of the application, such as characteristics of the source (e.g. website, document) containing the link/pointer from which a tab-associated website/web-application/application was accessed (e.g. a fishing related website, or a fishing related search, provided the link, hence the linked tab-associated website/web-application may be categorized as fishing/sports/outdoor related); (2) Information related to the actual website/web-application/local-application associated with the tab, such as a website's/web-application's/local-application's metadata, content, and/or the type of organization to which the website/web-application/application belongs and/or is affiliated with (e.g. a website identified as a website of a bank, for example Bank of America, may be categorized as finance related); (3) Information from an internal database/table of categorized websites and/or services (e.g. Google, Bing and Ask are categorized as ‘search engines’); and/or (4) Information from a third party database/table of categorized websites and services (e.g. Alexa.com).

According to some embodiments, personal, demographic, geographical and/or temporal based characterization may likewise be utilized, possibly in concert with the above described characterization information sources, and may include: (1) demographic information related to the user himself (e.g. age, gender, income); (2) geographical information related to the location from which the user has accessed, and/or is accessing, the website/web-service/web-application/local-application; and/or (3) temporal information related to the user's—current or logged—accessing and/or activities time spots/segments with the website/web-service/web-application/local-application.

According to some embodiments, based on some or all of the characterization data, and the type(s) and threshold levels of characterization features/attributes required for inclusion in each of the categories, each websites/web-services/web-applications/local-applications and/or their respective/associated tabs, may be initially categorized by the characterization module under system-defined and/or system-′understanding′ based and defined categories. The arrangement rule-set may further include user-defined or modified categories and/or attributes types and thresholds for inclusion therein, for the characterization module to apply beyond its initial/raw categorization.

According to some embodiments, exemplary categories and category types may include: (1) standard (content/service based) categories (e.g. sports, fishing, football, finance); (2) time based categories (e.g. tabs opened/accessed every morning/evening/3:00 pm/2 days/working day); (3) location based categories (e.g. tabs opened/accessed when at work/home/a-given-GPS-position); (4) user usage/interfacing based categories (e.g. opened/accessed as part of a sport equipment search, as part of new smart phone model research, opened/accessed in a short time period); and/or (5) any combination thereof (e.g. searching, on Friday night, for places to go out with a friend (a combination of time and content)).

According to some embodiments, a website/web-service/web-application/local-application may be categorized under more than one category, for example, based on different feature/attribute sets, such as: the type of service attribute (e.g. search, translate), geographic affiliation related attributes, volume of traffic related attributes, and/or the like.

According to some embodiments, a tab may be characterized using a lookup table which correlates or cross references URL's or internet addresses (e.g. for web browser applications), and/or pointers/links or memory addresses (e.g. for local applications), with specific content and/or service characterizations or categories. Content and/or service characterizations may be provided in the form of characterization terms, characterization values and/or characterization codes. As part of characterizing a given tab, the characterization module may reference one or more records of the lookup table using the URL or internet addresses associated with the given tab (e.g. URL to which the tab is pointing), and the characterization module may derive from one or more matching or identified table records one or more characterizations, such as characterization terms or characterization codes. Each of the one or more characterizations from the identified matching records may identify a category associated with the content/services rendered within a tab and the given tab may be characterized by, or associated with, the one or more content/service categories. The lookup table may be a static or dynamic table. The table records may be universal and/or at least partially user defined.

According to some further embodiments, a tab and its associated content may be characterized using metadata presented by a source of the content/service(s). According to yet further embodiments, a tab and its associated content may be characterized using natural language processing of metadata and/or content associated with the tab.

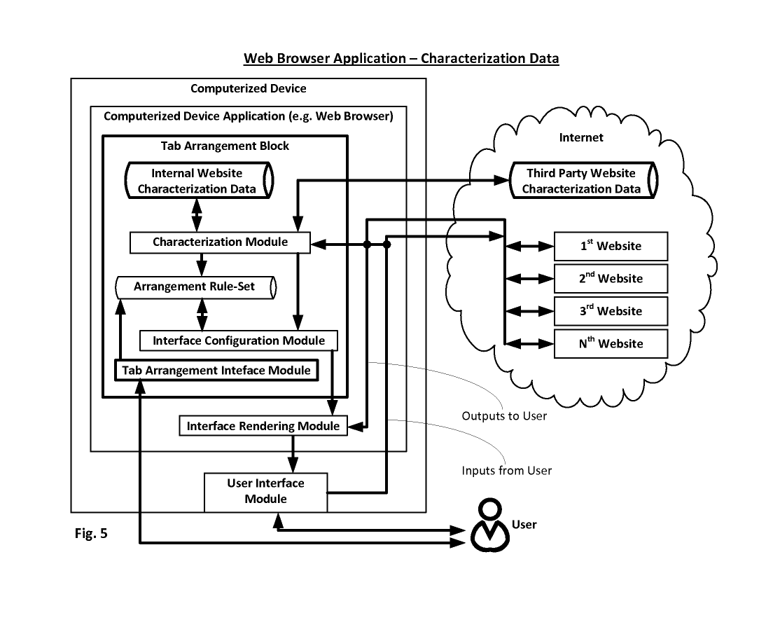

In FIG. 5 there is shown, in accordance with some embodiments of the present invention, a functional block diagram of an exemplary system for arranging content or service related tabs of a web-browser application wherein internal and external website characterization databases, and a tab arrangement interface module, are shown. According to some embodiments, as part of websites' content/service characterization, the Characterization Module references an Internal Website Characterization Database and/or an external (e.g. networked, e.g. Third Party) Website Characterization Database.

### Configuration

The interface configuration module may adjust location and appearance of tab rendering based on a rule-set, which rule-set may factor tab characterization or category associations. According to some embodiments, all tabs associated with the same or similar categories may be rendered in proximity with one another, for example as part of the same tab grouping. According to further embodiments, all tabs associated with complementing categories may be rendered in proximity with one another, for example as part of the tab grouping. Tab or tab group appearance and/or location may be adjusted or readjusted based on present relevance of content/services within the tabs/groups at a given instance.

According to some embodiments of the present invention, the Interface Configuration Module may rely, to an interface rendering module of the computerized application (e.g. a web-browser), tab configuration data that may at least partially affect one or more attributes of the computerized application's tab(s). According to some embodiments, the interface rendering module of the computerized application, may receive tab configuration data, instructing it to: (1) group, ungroup and/or subgroup tabs (2) arrange or rearrange a location of a tab (e.g. based on grouping); (3) adjust or readjust an appearance attribute of a tab such as, but not limited to, the color, size, border, shape, and/or label of a tab (e.g. based on grouping); and/or (4) allocate more, or less, computer/network/memory/storage resources to a tab or a service associated with a tab (e.g. increase the refresh rate of a service associated with a certain tab group).

According to some embodiments, a Tab Arrangement Interface Module, functionally associated with the Arrangement Rule Set database, may allow for a user to: (1) add, remove, or edit a tab associated content/service category and/or attributes thereof; (2) define or edit conditions, rules, and/or thresholds for inclusion, of content(s)/service(s) associated with a tab, in a given category; and/or (3) correlate between a given content/service category, and a tab configuration: grouping-rules, arrangement-rules, appearance-rules, and/or resource-allocation-rules attribute(s) or profile(s).

Returning to FIG. 5, there is shown, in accordance with some embodiments of the present invention, a Tab Arrangement Interface Module, functionally associated with the Arrangement Rule Set database, that allows for a user to make modifications to the Arrangement Rule-Set and thus to the interface configuration of the web browser's tabs.

According to some embodiments, the Interface Configuration Module may operate in: a static (e.g. when offline) mode—configuring the tabs of the computerized application based on an Arrangement Rule Set(s), that is the result of previously performed content/service characterizations and/or user interface inputs; and/or a dynamic mode—intermittently checking the Arrangement Rule Set for content/service characterization and/or user interface input updates, and accordingly reconfiguring one or more attributes of the computerized application's tabs as updates arrive, as updates accumulate beyond a certain threshold amount, and/or based on a temporal schedule.

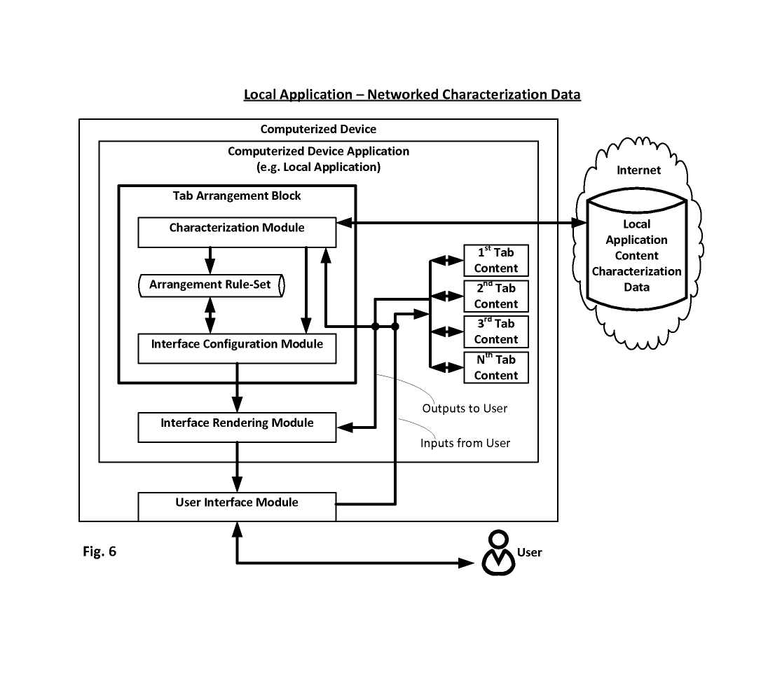

In FIG. 6 there is shown, in accordance with some embodiments of the present invention, a functional block diagram of an exemplary system for arranging content or service related tabs of a locally running application, wherein an external networked characterization database is used to characterize the content/service of the locally running, tab using, application.

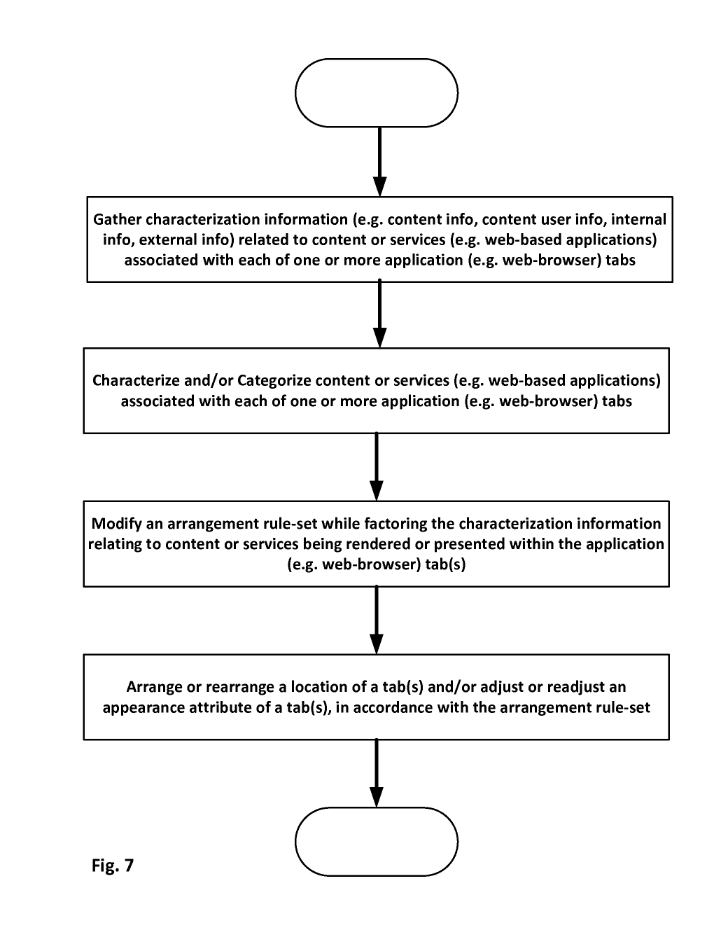

In FIG. 7 there is shown, in accordance with some embodiments of the present invention, a flowchart showing the main steps executed by an exemplary system for arranging content or service related tabs.

According to some embodiments of the present invention, all tabs associated with the same or similar categories may be rendered as part of the same tab grouping. According to some embodiments, at least some of an application's tabs may each contain a set of grouped (e.g. similarly categorized) tabs, while other tabs may be regular, directly linking, tabs. Selection (e.g. mouse swipe/click) of a tab containing a set of grouped tabs may open and present the tabs of the selected group. Selection of a tab from the selected group may directly link the user and/or may open and present a further sub-group (e.g. similarly sub-categorized) of tabs.

According to some embodiments, tabs of a selected group may be rendered and presented as: a ‘drop down’ menu, a ‘file view’ menu, a ‘floating balloons’ menu and/or via any other user interface configuration, known today or to be devised in the future.

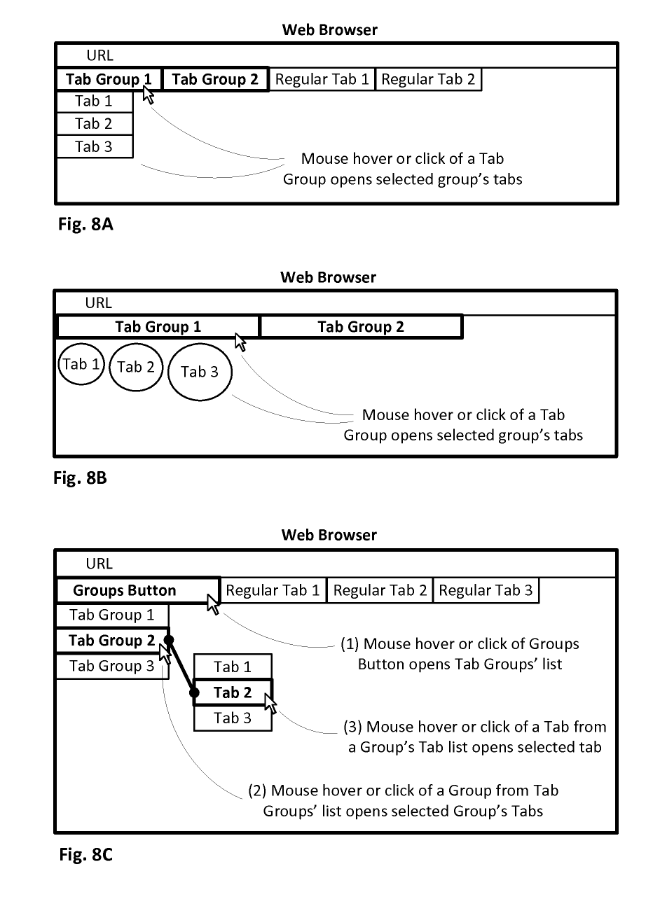

In FIG. 8A there is shown, a schematic web browser screen rendering of an exemplary tab arrangement, configured by a system for arranging content or service related tabs in accordance with some embodiments of the present invention, wherein some of the web browser tabs group a set of related tabs; and wherein grouped tabs, of a set of related tabs, are displayed as a ‘drop down’ menu when their group tab is selected.

In FIG. 8B there is shown, a schematic web browser screen rendering of an exemplary tab arrangement, configured by a system for arranging content or service related tabs in accordance with some embodiments of the present invention, wherein grouped tabs, of a set of related tabs, are displayed as ‘floating balloons’ when their group tab is selected.

According to some embodiments, one or more of an application's tabs may each contain a set of groups, of grouped (e.g. similarly categorized) tabs, while other tabs may be regular, directly linking, tabs. Selection (e.g. mouse swipe/click) of a tab containing a set of groups may open and present one or more tab groups to select from, selection of a tab group may open and present the tabs of the selected group, selection of a tab from the selected group may directly link the user and/or may open and present a further sub-group (e.g. similarly sub-categorized) of tabs.

In FIG. 8C there is shown, a schematic web browser screen rendering of an exemplary tab arrangement, configured by a system for arranging content or service related tabs in accordance with some embodiments of the present invention, wherein a tab groups list is displayed as a first ‘drop down’ menu when a designated ‘groups button’ tab is selected; and wherein grouped tabs, of a set of related tabs, are displayed as a second ‘drop down’ menu when their group is selected from the first ‘drop down’ menu;

According to some embodiments of the present invention, tab groups and/or regular tabs may be presented on a substantially large portion of a computerized device (e.g. a mobile device) display. Selection (e.g. finger touch/swipe) of a tab containing a set of grouped tabs may open and present on a substantially large portion of a computerized device display, and possibly in place of the previously presented tabs, the tabs of the selected group.

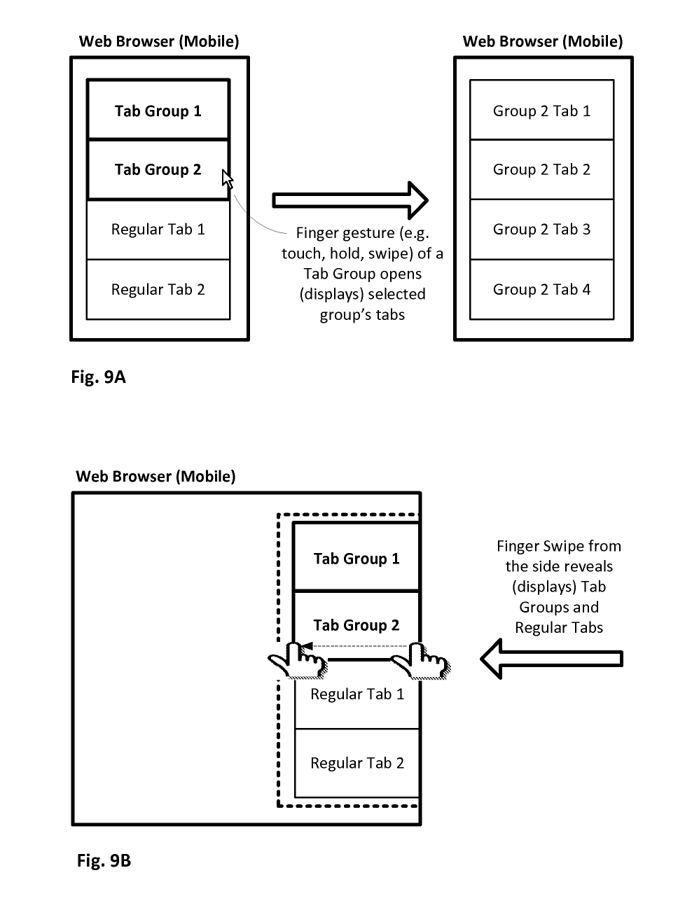

In FIG. 9A there is shown, a schematic, mobile device, web browser screen rendering of an exemplary tab arrangement, configured by a system for arranging content or service related tabs in accordance with some embodiments of the present invention, wherein some of the mobile web browser tabs group a set of related tabs; and wherein grouped tabs, of a set of related tabs, are displayed on the screen when their group tab is selected;

According to some embodiments of the present invention, tab groups and/or regular tabs menu may be revealed and presented on at least a portion of a computerized device (e.g. a mobile device) display when a user swipes the display's screen (e.g. from the side inward).

In FIG. 9B there is shown, a schematic, mobile device, web browser screen rendering of an exemplary tab arrangement, configured by a system for arranging content or service related tabs in accordance with some embodiments of the present invention, wherein some of the mobile web browser tabs group a set of related tabs; and wherein grouped tabs and regular tabs menu is revealed and displayed when the device screen is swiped from the side.

According to some embodiments of the present invention, a system for arranging content or service related tabs, may comprise: a characterization module to characterize content or services associated with each of one or more software application tabs; and an interface configuration module to configure one or more appearance attributes of some or all of the one or more tabs, based on an arrangement rule-set that at least partially factors information of tab associated content or services provided by said characterization module.

According to some embodiments, the characterization module may characterize content or services associated tabs, based on information related to the user's interfacing characteristics with the content or services associated with each of the one or more software application tabs.

According to some embodiments, the characterization module may characterize content or services associated tabs, based on information related to the actual content or services associated with each of the tabs.

According to some embodiments, the characterization module may characterize content or services associated tabs, based on information related to metadata of content or services associated with each of the tabs.

According to some embodiments, the characterization module may characterize content or services associated tabs, based on information from an internal database of categorized content or services.

According to some embodiments, the characterization module may characterize content or services associated tabs, based on information from a third party database of categorized content or services.

According to some embodiments, the characterization module may characterize content or services associated tabs, based on demographic, geographical and temporal user related information.

According to some embodiments, the characterization module may utilize its characterization information to categorize the tabs. According to some embodiments, the arrangement rule-set may include category arrangement rules defining tab arrangement for characterization module defined categories. According to some embodiments, the arrangement rule-set may include user defined or modified category arrangement rules. According to some embodiments, the category arrangement rules for rendering tabs associated with the same or similar categories may be selected from the group consisting of: tab proximity related rules, tab appearance attributes related rules.

According to some embodiments of the present invention, a method for arranging content or service related tabs may comprise: characterizing content or services associated with each of one or more software application tabs; and configuring one or more appearance attributes of some or all of the one or more tabs, based on an arrangement rule-set that at least partially factors information of tab associated content or services provided by the content or service characterization.

According to some embodiments, characterizing may include characterizing content or services associated tabs, based on information related to the user's interfacing characteristics with the content or services associated with each of the one or more software application tabs.

According to some embodiments, characterizing may include characterizing content or services associated tabs, based on information related to the actual content or services associated with each of the tabs.

According to some embodiments, characterizing may include characterizing content or services associated tabs, based on information related to metadata of content or services associated with each of the tabs.

According to some embodiments, characterizing may include characterizing content or services associated tabs, based on information from an internal database of categorized content or services.

According to some embodiments, characterizing may include characterizing content or services associated tabs, based on information from a third party database of categorized content or services.

According to some embodiments, characterizing may include characterizing content or services associated tabs, based on demographic, geographical and temporal user related information.

According to some embodiments, characterizing may further include utilizing characterization information to categorize the tabs. According to some embodiments, the method may further comprise defining category arrangement rules defining tab arrangement for characterization based categories. According to some embodiments, the method may further comprise facilitating the addition of user defined or modified category arrangement rules. According to some embodiments, the method may further comprise selecting category arrangement rules for rendering tabs associated with the same or similar categories from the group consisting of: tab proximity related rules, tab appearance attributes related rules.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed:

1. A system for arranging content or service related tabs, said system comprising:
a characterization module to characterize content or services associated with each of one or more software application tabs; and
an interface configuration module to configure one or more appearance attributes of some or all of the one or more tabs, based on an arrangement rule-set that at least partially factors information of tab associated content or services provided by said characterization module.

2. The system according to claim 1 wherein the characterization module characterizes content or services associated tabs, based on information related to the user's interfacing characteristics with the content or services associated with each of the one or more software application tabs.

3. The system according to claim 1 wherein the characterization module characterizes content or services associated tabs, based on information related to the actual content or services associated with each of the tabs.

4. The system according to claim 1 wherein the characterization module characterizes content or services associated tabs, based on information related to metadata of content or services associated with each of the tabs.

5. The system according to claim 1 wherein the characterization module characterizes content or services associated tabs, based on information from an internal database of categorized content or services.

6. The system according to claim 1 wherein the characterization module characterizes content or services associated tabs, based on information from a third party database of categorized content or services.

7. The system according to claim 1 wherein the characterization module characterizes content or services associated tabs, based on demographic, geographical and temporal user related information.

8. The system according to claim 1 wherein the characterization module utilizes its characterization information to categorize the tabs.

9. The system according to claim 8 wherein the arrangement rule-set includes category arrangement rules defining tab arrangement for characterization module defined categories.

10. The system according to claim 9 wherein the arrangement rule-set includes user defined or modified category arrangement rules.

11. The system according to claim 10 wherein the category arrangement rules for rendering tabs associated with the same or similar categories are selected from the group consisting of: tab proximity related rules, tab appearance attributes related rules.

12. A method for arranging content or service related tabs, said method comprising:
characterizing content or services associated with each of one or more software application tabs; and
configuring one or more appearance attributes of some or all of the one or more tabs, based on an arrangement rule-set that at least partially factors information of tab associated content or services provided by the content or service characterization.

13. The method according to claim 12 wherein characterizing includes characterizing content or services associated tabs, based on information related to the user's interfacing characteristics with the content or services associated with each of the one or more software application tabs.

14. The method according to claim 12 wherein characterizing includes characterizing content or services associated tabs, based on information related to the actual content or services associated with each of the tabs.

15. The method according to claim 12 wherein characterizing includes characterizing content or services associated tabs, based on information related to metadata of content or services associated with each of the tabs.

16. The method according to claim 12 wherein characterizing includes characterizing content or services associated tabs, based on information from an internal database of categorized content or services.

17. The method according to claim 12 wherein characterizing includes characterizing content or services associated tabs, based on information from a third party database of categorized content or services.

18. The method according to claim 12 wherein characterizing includes characterizing content or services associated tabs, based on demographic, geographical and temporal user related information.

19. The method according to claim 12 wherein characterizing further includes utilizing characterization information to categorize the tabs.

20. The method according to claim 19 further comprising defining category arrangement rules defining tab arrangement for characterization based categories.

21. The method according to claim 20 further comprising facilitating the addition of user defined or modified category arrangement rules.

22. The method according to claim 21 further comprising selecting category arrangement rules for rendering tabs associated with the same or similar categories from the group consisting of: tab proximity related rules, tab appearance attributes related rules.
